(19) United States
(12) Patent Application Publication
(10) Pub. No.: US 2016/0075199 A1
(43) Pub. Date: Mar. 17, 2016

(54) TOW DEVICE TO PROTECT CAR BODY

(71) Applicant: JOHN CHARLES HEROLD, CHARLES TOWN, WV (US)

(72) Inventor: JOHN CHARLES HEROLD, CHARLES TOWN, WV (US)

(21) Appl. No.: 14/756,496

(22) Filed: Sep. 10, 2015

Related U.S. Application Data
(60) Provisional application No. 62/071,019, filed on Sep. 12, 2014.

(51) Int. Cl. B60D 1/58; B60D 1/24; B60D 1/48

(52) U.S. Cl. CPC B60D 1/58; B60D 1/488; B60D 1/24

(57) ABSTRACT

A car body having an attached sub-frame for suspension of wheels, means on the sub-frame to attach a flexible towing element to the car, and means attached to the sub-frame to protect the car body from being engaged by the flexible element during towing. The protection means may be rigid plate welded to the sub-frame.

### CROSS-REFERENCE TO RELATED APPLICATION

The present application is based on and claims priority based on U.S. Provisional Application Ser. No. 62/071,019, filed Sep. 12, 2014.

### STATEMENT REGARDING FEDERALLY SPONSORED RESEARCH AND DEVELOPMENT

Not applicable.

### NAMES OF PARTIES TO JOINT RESEARCH AGREEMENT

Not applicable.

### STATEMENT REGARDING PRIOR DISCLOSURES BY THE INVENTOR

The inventor did not make any public disclosure of his invention prior to the effective date of this application which is claimed as Sep. 12, 2014, the date of filing the above-identified related US Provisional Application.

### BACKGROUND OF THE INVENTION

Some cars are designed with devices to assist and enable attachment of a tow cable, strap or chain that permits a tow truck or other device to tow the car. Typical instances where such towing is required include moving a disabled car onto a stationary flatbed truck and loading of trailers for transport of a car to an auction or car show.

### BRIEF SUMMARY OF THE INVENTION

The object of the present invention is to provide a tow attachment device that protects the car's body from being damaged during towing by the taut cable, etc. Such damage could include denting and scraping of the car's adjacent bodywork and paint which would be especially damaging in the case of “Concours’ level restoration of a vintage car.

### BRIEF DESCRIPTION OF THE DRAWINGS

FIG. 1 shows a newly painted car (1973 BMW 2002) ready to be towed up a ramp into a stationary trailer by way of a winch cable extending under the front of the passenger side of the car.

FIG. 2 shows the device of the present invention welded to the front of the existing sub-frame and its tow attachment loops.

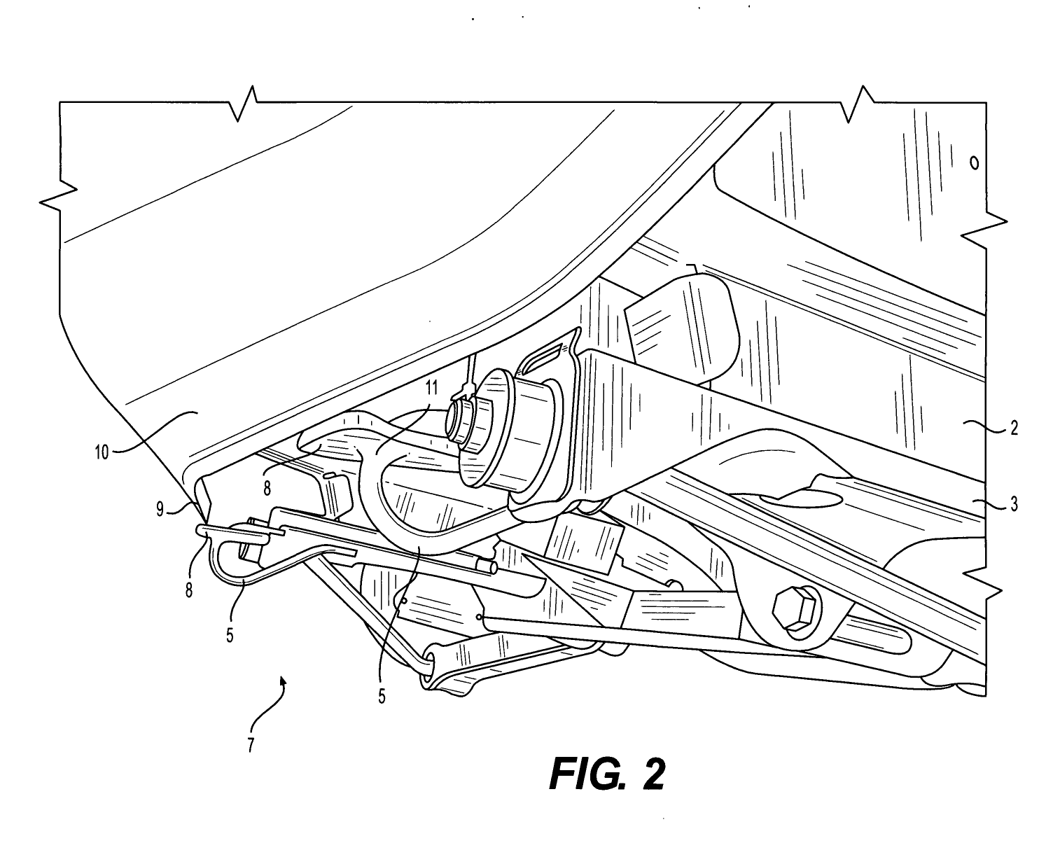

FIG. 3 shows the device of the present invention in the form of a fan-shaped horizontal metal plate extending forward of the sub-frame and underneath the damageable front end body of the car (e.g., the lower sheet metal valance).

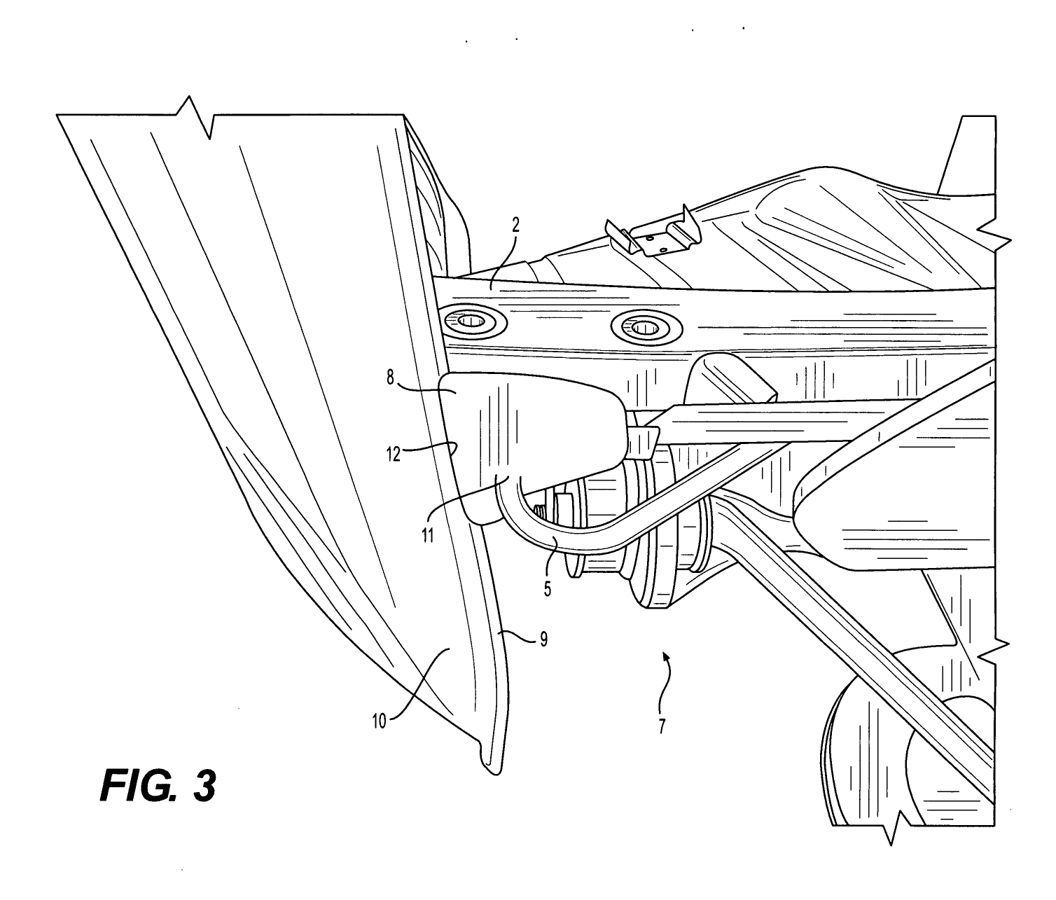

FIG. 4 shows the present invention as it is mounted under the sub-frame under the frame rail of the passenger side of the car shown in FIG. 1.

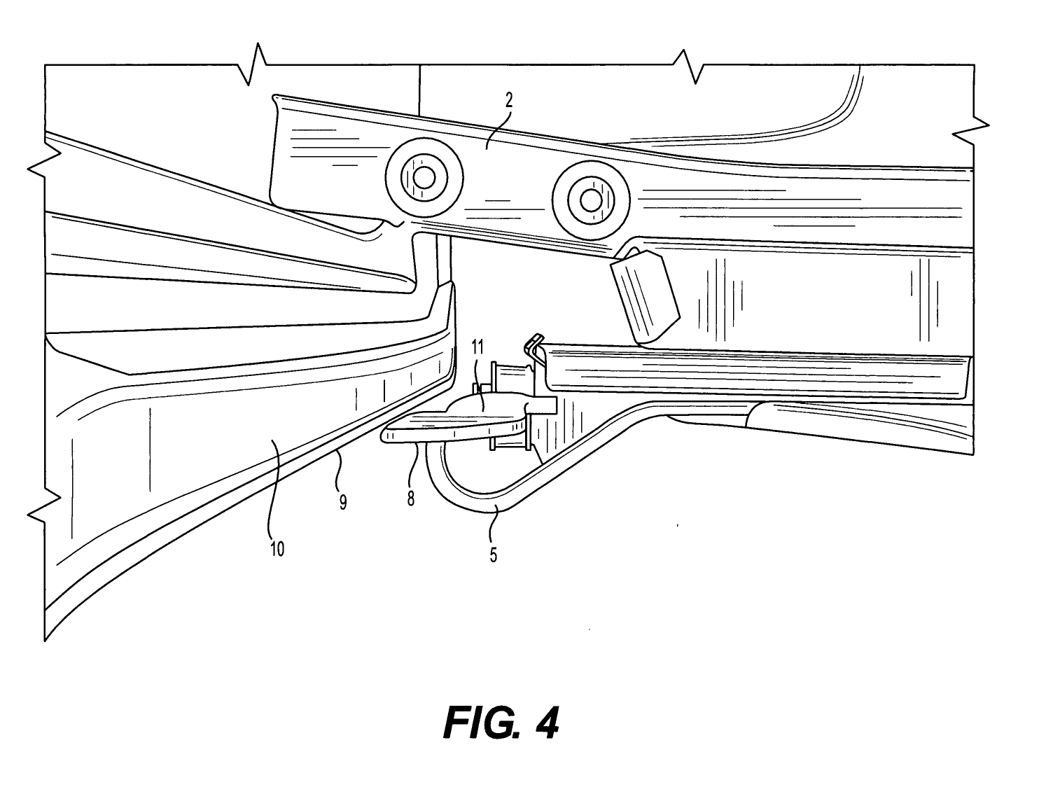

### DETAILED DESCRIPTION OF THE INVENTION

The disclosure of related U.S. Provisional Application Ser. No. 62/071,019 is incorporated herein by reference.

The tow attachment device of the present invention comprises a protective metal plate 8 that is rigidly attached (e.g. welded as shown at welds 11) to the sub-frame 3 of the car 1 and oriented over the usual tow loops 5 (BMW Part No. 31112406105 known as a towing bracket for vintage car BMW Model 2002, among others) for a flexible cable 6, strap or chain. The protective metal plate 8 extends forward of the sub-frame 3 and its fan-shaped edge 12 lies underneath the front edge 9 of the finished body panel 10 (e.g. valance). Sub-frame 3, also known as a front axle suspension for wheels 4, is attached to the underside of the car body 1 by way of the frame rails 2.

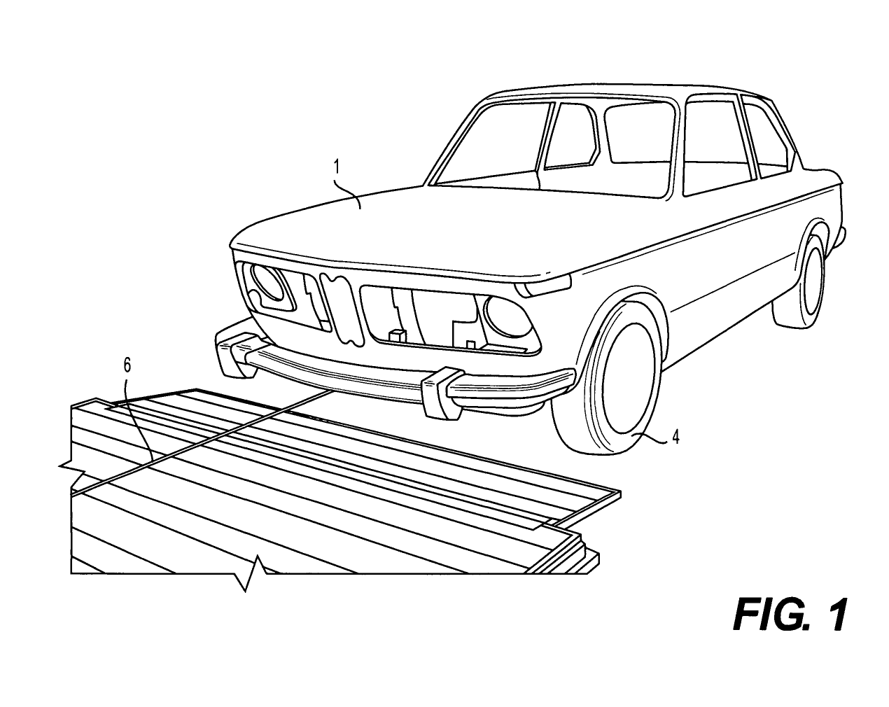

In use, the protective plate 8 lies over the cable 6 so that it, instead of the body panel 9-10, is engaged by the taut/moving cable 6 when the cable is pulled taut or changes its angle of orientation relative to the sub-frame 3 as, for example, what occurs when towing a car onto a transport trailer by way of a ramp as seen in FIG. 1

Many variations of the present invention are envisioned. For example, the protective plate can be a metal plate welded to the existing tow attachment point of a sub-frame or other frame part. The plate can be provided by extension of the sub-frame during original manufacture of the frame. Also, the present invention can be provided on the front or rear of the car on respective sub-frames, or on both. Further, the present invention can be provided by being removably attached by fasteners to a sub-frame at the time of towing and then being removed after the towing is complete. Still further variations may be done within the scope of the present invention as will be apparent to persons skilled in this field.

I claim:

1. In the combination of a car body having an attached sub-frame for suspension of wheels, the improvement comprising:
means on said sub-frame for attaching a flexible towing element to said car, and
means attached to said sub-frame for protecting said body from being engaged by said element during towing.

2. The invention of claim 1, wherein said means for protecting said body includes a rigid plate positioned over said means for attaching said flexible towing element.

3. The invention of claim 2, wherein said body has a lower valance of sheet metal positioned downwardly, and said rigid plate has an edge which is positioned under said valance.

4. The invention of claim 2, wherein said rigid plate is attached to said sub-frame by a weld.

5. The invention of claim 4, wherein said rigid plate includes a fan-shaped edge.

6. The invention of claim 4, wherein there are two spaced said means for attaching a flexible towing element and respective rigid plates attached to said sub-frame.

7. The invention of claim 1, wherein said body includes a frame rail and said sub-frame is attached to said frame rail.

8. The invention of claim 1, wherein said means for attaching a flexible towing element is a metal loop attached to said sub-frame.

9. The invention of claim 1, wherein said means for protecting said body includes a rigid plate attached to said sub-frame by a means for removably attaching said plate to said sub-frame.
